(19) United States
(12) Patent Application Publication
(10) Pub. No.: US 2008/0155166 A1
(43) Pub. Date: Jun. 26, 2008

(54) Application specific processor for controlling data buffer manager

(75) Inventors: Michael James, Longmont, CO (US); Scott Richmond, Boulder, CO (US)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/644,186

(22) Filed: Dec. 22, 2006

(51) Int. Cl. G06F 12/00; G06F 13/00; G06F 11/00

(52) U.S. Cl. 711/4; 711/118; 714/21; 711/E12.017; 711/E12.001; 714/E11.002

(57) ABSTRACT

A buffer manager for controlling a buffer in a disk drive having a main control processor for performing functions relating to transfer of data between a host and disk media includes a processor for managing caching algorithms with respect to the buffer. A memory in communication with the processor stores instructions executed by the processor in performing the caching algorithms, and a storage unit stores data used by the processor in performing the caching algorithms.

### FIELD OF INVENTION

The present invention relates to disk drives, and in particular to an integrated circuit used to control temporary storage of data in semiconductor memory (buffer) on a disk drive.

### BACKGROUND OF THE INVENTION

Hard disk controllers (HDC) in disk drives typically include a buffer controller for controlling a buffer, which stores data such as user data, disk drive variables tables, code for control and/or servo processor execution and defect management information. One of the buffer controller responsibilities includes management of caching algorithms. This involves searching for a cache hit or miss for each command, and allocation of segments of the buffer for different commands or sets of commands.

In known hard disk controllers, the buffer controller, the buffer data and its management are controlled by the main control processor of the disk drive. These tasks take time away, or even prevent, the main control processor from performing its other duties. It is also known to employ a finite state machine device for controlling the buffer functions. As known in the art, a finite state machine is a model of behavior of states, transitions, and actions. State machine devices, while generally fast, lack flexibility, because they are programmed or constructed to interact with the buffer only in accordance with the state of the art knowledge and understanding of disk caching algorithms. They cannot be readily reprogrammed to adapt to changes in the caching algorithms.

### SUMMARY OF THE INVENTION

The present invention relates to a buffer manager for controlling a buffer in a disk drive having a main control processor for performing functions relating to transfer of data between a host and disk media. The buffer manager includes a processor for managing caching algorithms with respect to the buffer, memory in communication with the processor for storing instructions executed by the processor in performing the caching algorithms, and a storage unit for storing data used by the processor in performing the caching algorithms.

### BRIEF DESCRIPTION OF THE DRAWINGS

FIG. 1 is a block diagram of a disk drive in accordance with one embodiment of the present invention;

FIG. 2 is a block diagram of a hard disk controller shown in FIG. 1;

FIG. 3 is a block diagram of a buffer manager shown in FIG. 2 and a buffer shown in FIG. 1; and

FIG. 4 is a flowchart describing the read and write operations of the application specific processor in accordance with one embodiment of the present invention.

### DETAILED DESCRIPTION OF THE PREFERRED EMBODIMENTS

Broadly stated, the present invention relates to an application specific processor (ASP) for controlling the buffer manager of a disk drive. In prior art disk drives, the buffer manager control is handled by the main control processor (MCP). The ASP of the present invention relieves the MCP from buffer manager controlling functions, thus allowing the MCP to focus on other functions. The ASP of the present invention can be reprogrammed to suit the changing conditions in the cache algorithms for handling data access in the buffer. This feature adds flexibility to the control of the buffer, unlike other known buffer manager controllers such as finite state machine devices which cannot be reprogrammed once implemented.

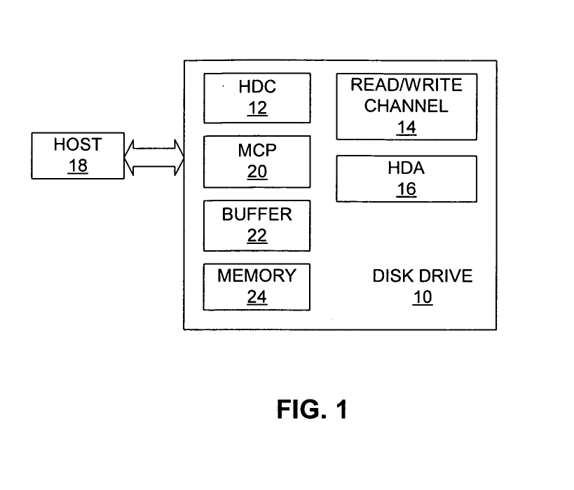

Turning now to FIG. 1, a disk drive 10 in accordance with one embodiment of the present invention includes a hard disk controller (HDC) 12, a read/write channel 14 and a head disk assembly (HDA) 16. The disk drive 10 may be a magnetic, optical or magneto-optical drive, and is adapted to be communicatively connected to a host device 18 such as a computer.

The disk drive 10 further includes a main control processor (MCP) 20, a buffer 22 and a memory 24. The MCP 20 is provided for overall control of the disk drive 10 including control and management of mechanical positioning of heads and rotational media (motor controls) in the HDA 16, control and setup of the read/write channel 14 and host interface, for example. The buffer 22 is preferably implemented in a DRAM or other memory devices such as FLASH or SRAM, and stores data used by the MCP 20 and the HDC 12 such as user data, disk drive variables tables, code for servo processor execution and defect management information. The memory 24 is a nonvolatile storage device such as FLASH memory or a ROM. The memory 24 stores programs and tables used in accomplishing the above-mentioned MCP 20 responsibilities, including control and setup of read channel and storing codes to be executed by the MCP.

The HDA 16, although not shown, includes one or more disks, a spindle motor for rotating the disk(s), a read/write head(s) for reading data from and writing data on the disk(s), and a head actuator for positioning the head(s) on the disk(s). The read/write channel 14 is provided for translation of digital data from the HDC 12 to a format capable of being either written to, or read from the disk(s) in the HDA 16. In a disk write operation, the read/write channel 14 sends signals to a write head and a preamp to cause magnetic transitions to be “written” to the disks. For a disk read operation, the read/write channel 14 decodes the signals from a read head and the preamp generated by passing over the magnetic or optical domains written to the disks. The transitions are detected and processed in a manner that allows them to be converted into a data format usable by the HDC 12 and the host device 18.

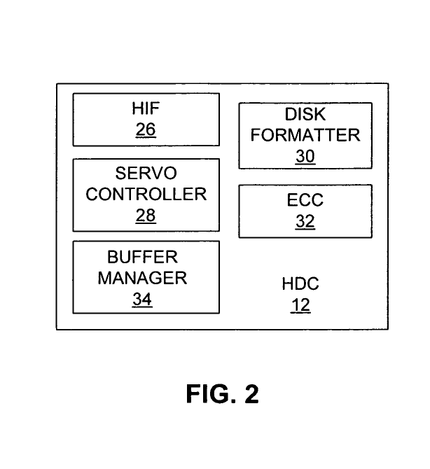

Referring to FIG. 2, the HDC 12 includes a host interface (HIF) 26 for processing commands from the host 18, and transmitting and accepting data to and from the host. Status to the host device 18 regarding successes or errors of the commands is also generated by the HIF 26. A servo controller 28 is provided for controlling the HDA 16 including the rotational speed of the spindle motor used to rotate the disks and positioning of the read/write head.

The HDC 12 also includes a disk formatter 30 for transferring data from the buffer 22 (shown in FIG. 1) to the read/write channel 14, and reading data from the disk and transferring that data to the buffer. The timing of when to write or read data to or from the disk is controlled by the disk formatter 30. Two signals (Read Gate and Write Gate) are typically communicated to the read/write channel 14 for an indication of when to process data.

The error correcting code (ECC) circuit 32 is provided for testing the accuracy of data as it passes in and out of the disk formatter 30. Disk drive data is generally very faint in signal size, and therefore, some errors are made in retrieval of data from the disk media. Many of these errors are corrected by the use of the ECC circuit 32.

A buffer manager 34 is used to interface between the HIF 26 and the buffer 22, or between the disk formatter 30 and the buffer. The HIF 26 and the disk formatter 30 make requests of the buffer manager 34 to either accept data and write it to the buffer 22, or to retrieve data from the buffer. Other components of the HDC 12 may also have interfaces to the buffer manager 34 to be able to store and retrieve data from the buffer 22, including the ECC circuit 32. The buffer manager 34 responsibilities include management of caching algorithms, which involves searching for a cache hit or miss for each command, and allocation of segments of the buffer 22 for different commands or sets of commands.

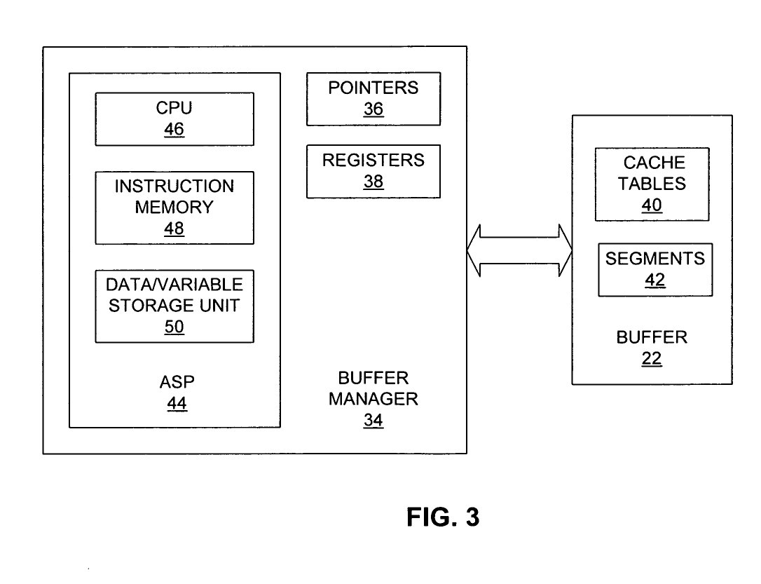

As shown in FIG. 3, the buffer manager 34 includes pointers 36 for the disk(s), the host device 18, the disk formatter 30, and any other component of the HDC 12 that wish to access the buffer 22. Buffer manager 34 also includes registers 38 for holding addresses of user data in the buffer 22. The buffer 22 includes a cache table 40 for indicating the location of user data stored in the buffer segments 42 that also make up the buffer. In other words, the cache table 42 contains a list of which LBA's (logical blocking addressing) data are stored for a disk read, or available for a disk write, at which buffer locations. The registers 38 are programmed from the contents of the cache table 40.

In accordance with one embodiment of the present invention, the buffer manager 34 also includes an ASP 44 for controlling the buffer manager 34. The ASP 40 is preferably a microprocessor and includes a central processing unit (CPU) 46 for enabling the designed functions of the ASP, primarily cache algorithms including table look up for cache hits/misses, allocation of space in the buffer 22 for each command, and updating of the cache tables 40 to reflect the allocation of buffer space. The ASP 44 further includes an instruction memory 48 that contains instructions executed by the CPU 46, and a local data/variable storage unit 50 for storing data used by the CPU 46 in performing its functions. One advantage of the present microprocessor-based buffer manager 34 is that the ASP 44 can be reprogrammed as necessary to make adjustments to the cache algorithms.

In operation, the ASP 44 enables caching algorithms, which include translation of incoming disk commands from the host device 18. For a read command, the caching algorithms include searching the cache tables 40 to determine if all, or any portion of the data is contained in the buffer 22. For a cache hit, the data is transferred as soon as practicable to the host device 18. For a cache hit that contains only a part of the requested data, or a cache miss, the MCP 20 and the servo controller 28 are informed of the need to read data from the disk(s) in the HDA 16.

For a disk write command, the ASP 44 allocates a space in the segments 42 of the buffer 22 and updates the cache tables 40. The ASP 44 then notifies the MCP 20 and the servo controller 28 of the data available to be written to the disk(s).

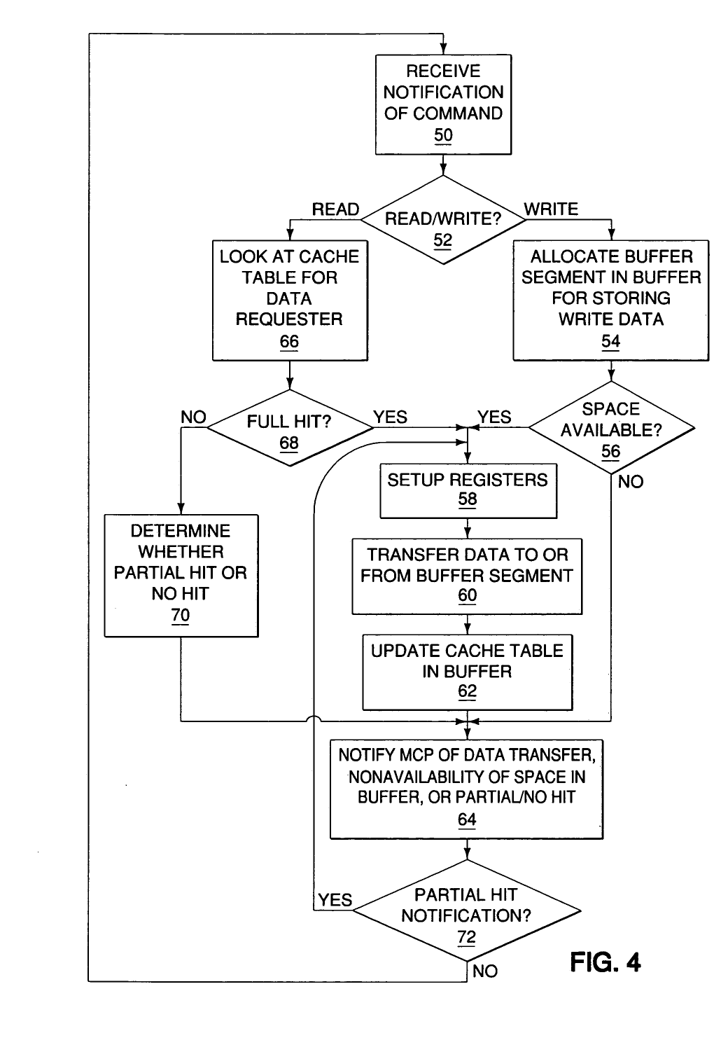

Referring now to FIG. 4, a more detailed cache algorithms performed by the ASP 44 is described. When the ASP 44 receives a notification from HIF 26 that a valid command has been issued by the host device 18 (block 50), it determines whether the command is for a disk read or write (block 52).

If the command from the host device 18 is a disk write, the ASP 44 searches the cache tables 40 in the buffer 22 (which contain information as to what data is in the buffer segments 42), and determines which buffer segment will be allocated to accept and store the host write command data (block 54). If there is space to accept the host write data (block 56), the registers 38 used to control the transfer of data between the host device 18 and buffer 22 or between the disk and buffer, are programmed or setup by the ASP 44 to transfer host data to the location of the buffer allocated by the cacheing algorithms (block 58). The data is then transferred to the determined buffer segments 42 (block 60). Preferably, a small state machine device (not shown) is provided to use the registers 38 to interface with the buffer 22 in transferring the data. This state machine device is specific to the buffer 22 and is transparent to the buffer manager 34.

Once the data is transferred to the buffer segments 42, the ASP 44 updates the cache tables 40 in the buffer 22 to reflect the new state of the buffer segments (block 62). The ASP 44 then notifies the MCP 20 of the completion of the data transfer (block 64).

Going back to decision block 56, if there is no space available in the buffer 22, the MCP 20 is notified of this by the ASP 44 (block 64). The MCP 20 then communicates this information to the HIF 26, and delays transmission of host write data until there is space available.

If the command from the host device 18 is a disk read (block 52), the ASP 44 searches the cache tables 40 in the buffer 22 for the data requested by the host read command (block 66).

If the cache tables 40 show that the data requested by the command is contained in the buffer 22 (a “full hit”) (block 68), a similar process described above in decision blocks 58-64 occurs. More specifically, the hardware registers 38 used to control the transfer of data between the host device 18 and buffer 22 or between the disk and buffer, are programmed by the ASP 44 (block 58), and the data is transferred from the buffer to the host device 18 (block 60). Once the data is transferred, the ASP 44 updates the cache tables 40 in the buffer 22 to reflect the new state of the buffer (block 62). The ASP 44 then notifies the MCP 20 of the completion of the data transfer (block 64).

On the other hand, if the search in the cache tables 40 (block 66) does not result in a full hit (block 68), the ASP 44 determines whether the search is a partial hit, i.e., only a part of the data requested by the host read command is contained in the buffer memory 22, or a “no hit,” i.e., no data requested by the host read command is contained in the buffer (block 70). The result of the search, i.e., a partial hit or a no hit, is communicated to the MCP 20 (block 64).

The MCP 20 receives notifications of the completion of data transfers, the need for more space, the need to retrieve data from the disk (when read search result in a no hit) or the need to retrieve the remainder of the data to satisfy the host read command (when the read search results in a partial hit). If the notification received by the MCP 20 is a partial hit, the process described in decision blocks 58-64 is repeated to transfer the partial data to the host device 18 (block 70). Otherwise, the process returns to decision block 50, where the ASP 44 again waits to receive a command.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A buffer managing apparatus for controlling a buffer in a disk drive having a main control processor for performing functions relating to transfer of data between a host and disk media, said apparatus comprising:
a processor for managing caching algorithms with respect to the buffer;
a memory in communication with said processor for storing instructions executed by said processor in performing said caching algorithms; and
a storage unit in communication with said processor for storing data used by said processor in performing said caching algorithms.

2. The buffer managing apparatus as defined in claim 1, wherein said processor comprises a reprogrammable microprocessor.

3. The buffer managing apparatus as defined in claim 1, wherein said caching algorithms comprise performing a data write operation for storing data on the buffer, and a data read operation for retrieving data from the buffer.

4. The buffer managing apparatus as defined in claim 3, wherein said data write operation includes allocating space in the buffer for data to be stored and updating cache tables in the buffer.

5. The buffer managing apparatus as defined in claim 3, wherein said data read operation includes searching cache tables in the buffer to determine whether the data to be retrieved is stored in the buffer, and retrieving the data from the buffer if the cache tables indicate that the data is stored in the buffer.

6. The buffer managing apparatus as defined in claim 1, further comprising registers for holding addresses of data stored in the buffer.

7. A disk controller for a disk drive having a main control processor for performing functions relating to transfer of data between a host and disk media, and a buffer for storing data received from and to be transmitted to the host, said disk controller comprising:
a host interface for receiving data from and transmitting data to the host;
a disk formatter for transferring data between the buffer and the disk media; and
a buffer manager for writing data in and retrieving data from the buffer;
said buffer manager including a processor for managing caching algorithms with respect to the buffer.

8. The disk controller as defined in claim 7, wherein said buffer manager further comprises:
a memory in communication with said processor for storing instructions executed by said processor in performing said caching algorithms; and
a storage unit in communication with said processor for storing data used by said processor in performing said caching algorithms.

9. The disk controller as defined in claim 7, wherein said processor is a reprogrammable microprocessor.

10. The disk controller as defined in claim 7, wherein said caching algorithms comprises allocating space in the buffer for data to be stored and updating cache tables in the buffer, and searching the cache tables for determining whether the data to be retrieved is stored in the buffer, and retrieving the data from the buffer if the cache tables indicate that the data is stored in the buffer.

11. The disk controller as defined in claim 7, further comprising:
an error correction code device for checking accuracy of data going into and out of said disk formatter; and
a servo controller for controlling the disk media.

12. A disk drive comprising:
a head disk assembly including at least one disk medium for storing data;
a main control processor for performing functions relating to transfer of data between a host connected to the disk drive and said head disk assembly;
a buffer for storing data received from and to be transmitted to the host;
a host interface for receiving data from and transmitting data to the host;
a disk formatter for transferring data between the buffer and the disk media; and
a buffer manager for writing data in and retrieving data from the buffer;
said buffer manager including a processor for managing caching algorithms with respect to the buffer.

13. The disk drive as defined in claim 12, wherein said processor is a reprogrammable microprocessor.

14. The disk drive as defined in claim 12, wherein said caching algorithms comprise performing a data write operation for storing data on the buffer, and a data read operation for retrieving data from the buffer.

15. The disk drive as defined in claim 12, further comprising:
a read/write channel for translating data to a format that enables the data to be written to and read from said at least one disk medium in said head disk assembly; and
a memory for storing programs and tables for enabling said main control processor to perform said functions.

16. The disk drive as defined in claim 12, wherein said disk drive comprises a magnetic, an optical or a magneto-optical drive.
